(19) United States
(12) Patent Application Publication
(10) Pub. No.: US 2014/0153264 A1
(43) Pub. Date: Jun. 5, 2014

(54) AQUARIUM LAMP BRACKET ASSEMBLY

(71) Applicant: EIKO ELECTRIC PRODUCTS CORP., Taipei (TW)

(72) Inventor: Yu-Chin WANG, Taipei (TW)

(73) Assignee: EIKO ELECTRIC PRODUCTS CORP., TAIPEI (TW)

(21) Appl. No.: 13/705,772

(22) Filed: Dec. 5, 2012

(51) Int. Cl. F21V 21/092; F21V 21/088

(52) U.S. Cl. CPC F21V 21/092; F21V 21/088
USPC 362/389; 362/396

(57) ABSTRACT

An aquarium lamp bracket assembly includes a bracket including a base frame, a coupling tube located at the front side of the base frame defining an axial coupling hole and a longitudinal opening and a clamping member extended from the back side of the base frame and defining with the elongated base member a clamping mouth for fastening to a glass panel of an aquarium housing, and an adjustable lamp tube holder including a pivot shaft angularly adjustably mounted in the coupling hole in the coupling tube, a lamp tube holder shell holding a lamp tube and and a neck connected between the pivot shaft and the lamp tube holder shell and inserted through the longitudinal opening of the bracket.

### BACKGROUND OF THE INVENTION

1. Field of the Invention

The present invention relates to lighting technology for aquarium and more particularly, to an aquarium lamp bracket assembly, which can be conveniently fastened to one glass panel of an aquarium housing to hold a lamp tube in an angular position adjustable manner.

2. Description of the Related Art

An aquarium needs to be equipped with a lighting device at the top side to provide illumination. An early design of lighting device for aquarium generally comprises a fluorescent lamp tube, a lampshade surrounding the upper side of the fluorescent lamp tube, and a mounting device mountable at an aquarium housing to hold the lampshade and the fluorescent lamp tube.

However, when a conventional mounting device is fastened to an aquarium to hold a lighting device, it does not allow adjustment of the radiating angle of the light device.

Taiwan Utility Model M273952 discloses a lighting device for aquarium, entitled “Three-dimensional space adjustable lamps and lanterns”. This design of lighting device does not occupy much aquarium top space and allows adjustment of the radiating direction of the lamp tube. However, the mounting structure of this design of lighting device uses a complicated joint for allowing adjustment of the radiating angle of the lamp tube. The fabrication of this complicated joint requires much labor and time, resulting in high cost.

### SUMMARY OF THE INVENTION

The present invention has been accomplished under the circumstances in view. It is the main object of the present invention to provide an aquarium lamp bracket assembly, which has a compact structure and can be conveniently fastened to one glass panel of an aquarium housing by clamping. It is another object of the present invention to provide an aquarium lamp bracket assembly, which allows adjustment of the light radiating angle of the lamp tube. It is still another object of the present invention to provide an aquarium lamp bracket assembly, which can be conveniently fastened to one glass panel of an aquarium housing by a vacuum suction force.

To achieve these and other objects of the present invention, an aquarium lamp bracket assembly comprises a bracket and an adjustable lamp tube holder. The bracket comprises an elongated base frame, a coupling tube located at a front side of the base frame, a coupling hole axially defined in the coupling tube, a longitudinal opening cut through the periphery of the coupling tube and kept in communication with the coupling hole, a positioning means located at the inner perimeter of the coupling tube within the coupling hole, and a clamping member extended from a back side of the elongated base frame and defining a clamping mouth for fastening to a glass panel of an aquarium housing. The adjustable lamp tube holder comprises a pivot shaft inserted into the coupling hole in the coupling tube and kept in friction engagement with the positioning means, a lamp tube holder shell for holding a lamp tube, and a neck connected between the periphery of the pivot shaft and a back side of the lamp tube holder shell and inserted through the longitudinal opening of the bracket.

Further, the clamping member of the bracket comprises a first sloping wall obliquely extended from one lateral side of the elongated base frame, a pressure plate disposed in proximity to an opposite lateral side of the elongated base frame and defining with the opposite lateral side of the elongated base frame the clamping mouth, and a second sloping wall obliquely connected between the first sloping wall and the pressure plate.

Further, the clamping member of the bracket further comprises an auxiliary clamping plate located at an inner side of the first sloping wall and kept in proximity to the elongated base frame.

Further, the bracket further comprises a mounting means formed integral with the clamping member for mounting. Further, the mounting means can be a vacuum mount.

Further, the positioning means of the bracket comprises a plurality of longitudinal positioning teeth spaced around the inner perimeter of the coupling tube within the coupling hole. Further, the pivot shaft of the adjustable lamp tube holder is peripherally toothed for friction engagement with the longitudinal positioning teeth of the bracket.

### BRIEF DESCRIPTION OF THE DRAWINGS

FIG. 1 is a front view of an aquarium lamp bracket assembly in accordance with the present invention.

FIG. 2 is an exploded view of the aquarium lamp bracket assembly in accordance with the present invention.

FIG. 3 corresponds to FIG. 1, illustrating the angular position of the adjustable lamp tube holder adjusted relative to the bracket.

FIG. 4 is a schematic front view of an alternate form of the aquarium lamp bracket assembly in accordance with the present invention.

FIG. 5 is a schematic applied view of the present invention, illustrating the clamping member of the aquarium lamp bracket assembly clamped on the housing of an aquarium and the angular position of the lamp tube adjusted.

FIG. 6 is a schematic drawing illustrating an aquarium lamp bracket assembly used in an aquarium in accordance with the present invention.

### DETAILED DESCRIPTION OF THE PREFERRED EMBODIMENT

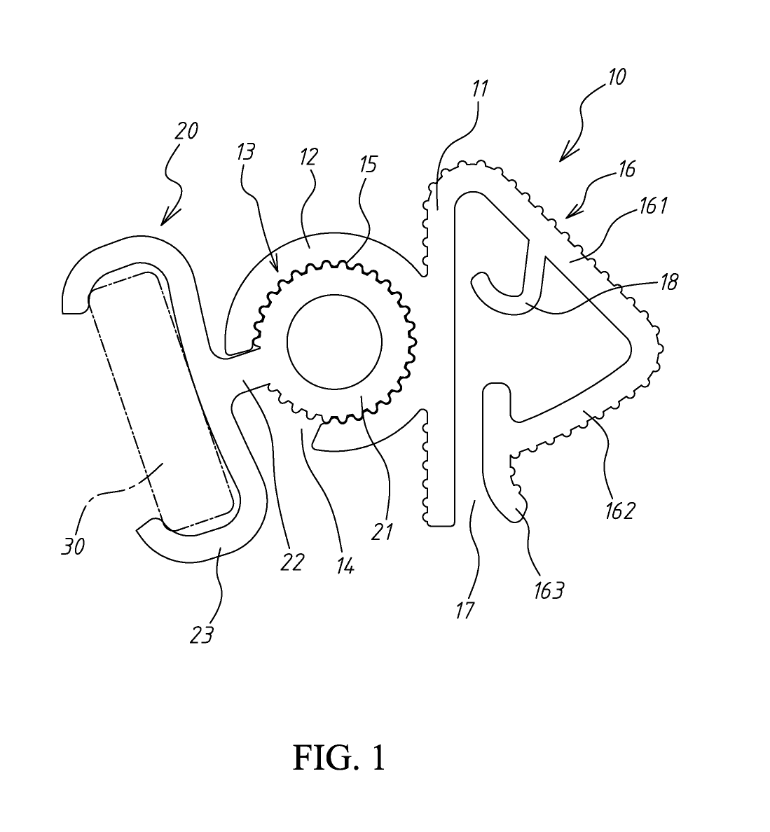

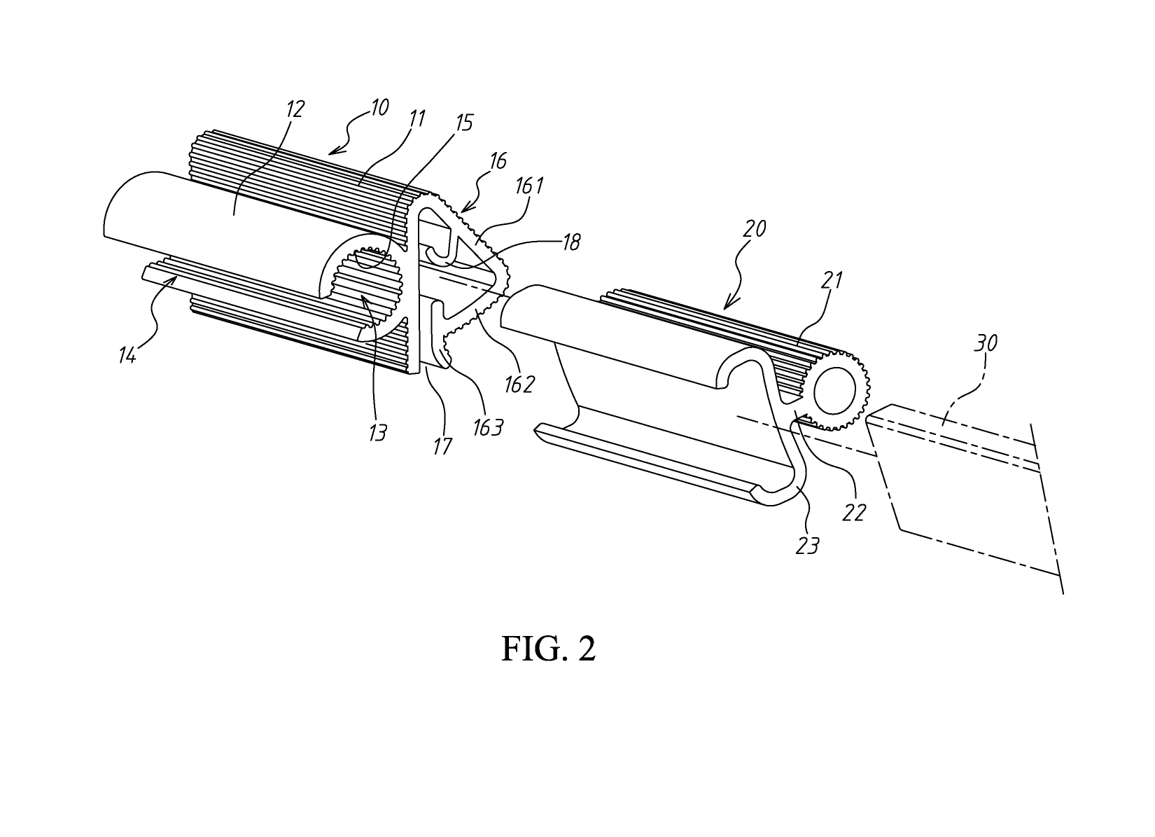

Referring to FIGS. 1 and 2, an aquarium lamp bracket assembly in accordance with the present invention is shown. The aquarium lamp bracket assembly comprises a bracket 10, and an adjustable lamp tube holder 20 mounted in the bracket body 10 to hold a lamp tube 30. The lamp tube 30 can be, for example, but not limited to, a LED tube.

The bracket 10 comprises an elongated base frame 11, a coupling tube 12 located at one side of the base frame 11, a coupling hole 13 axially defined in the coupling tube 12, a longitudinal opening 14 cut through the peripheral wall of the coupling tube 12 and kept in communication with the coupling hole 13, a positioning means, for example, longitudinal positioning teeth 15 spaced around the inner perimeter of the coupling tube 12 within the coupling hole 13, and a clamping member 16 extended from one lateral side of the elongated base frame 11, and clamping mouth 17 defined between the opposite lateral side of the elongated base frame 11 and the distal end of the clamping member 16.

Preferably, the clamping member 16 comprises a first sloping wall 161 obliquely extended from one lateral side of the elongated base frame 11, a pressure plate 163 disposed in proximity to the opposite lateral side of the elongated base frame 11 and defining with the opposite lateral side of the elongated base frame 11 the aforesaid clamping mouth 17, and a second sloping wall 162 obliquely connected between the first sloping wall 161 and the pressure plate 163.

More preferably, an auxiliary clamping plate 18 is located at the inner side of the first sloping wall 161 and kept in proximity to the elongated base frame 11.

The adjustable lamp tube holder 20 comprises a peripherally toothed pivot shaft 21 inserted into the coupling hole 13 in the coupling tube 12 and kept in friction engagement with the longitudinal positioning teeth 15, a lamp tube holder shell 23 having an inverted U-shaped profile for holding the lamp tube 30 for enabling the lamp tube 30 to emit light radially toward the outside of the aquarium lamp bracket assembly, and a neck 22 connected between the toothed periphery of the peripherally toothed pivot shaft 21 and a back side of the lamp tube holder shell 23 and inserted through the longitudinal opening 14 of the bracket 10.

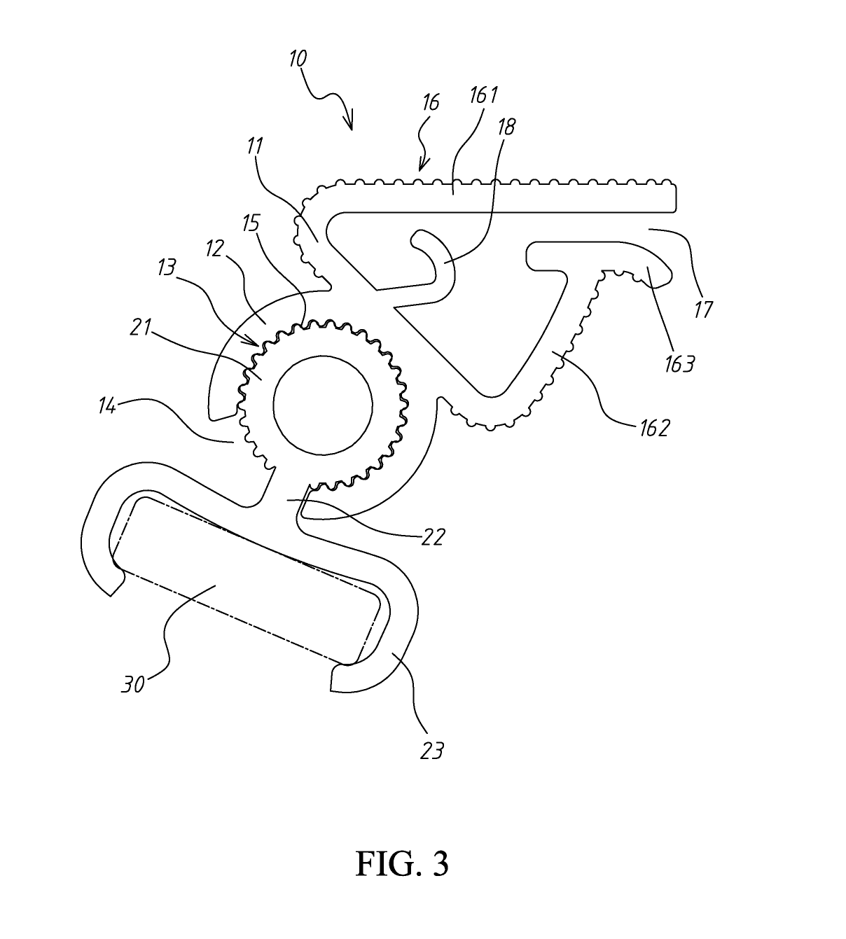

Referring to FIG. 3, an alternate form of the aquarium lamp bracket assembly is shown. This alternate form is substantially similar to that shown in FIG. 1 with the exception of the extending direction of the clamping mouth 17. In the embodiment shown in FIG. 1, the clamping mouth 17 extends vertically downwards. In the embodiment shown in FIG. 3, the clamping mouth 17 extends in horizontally.

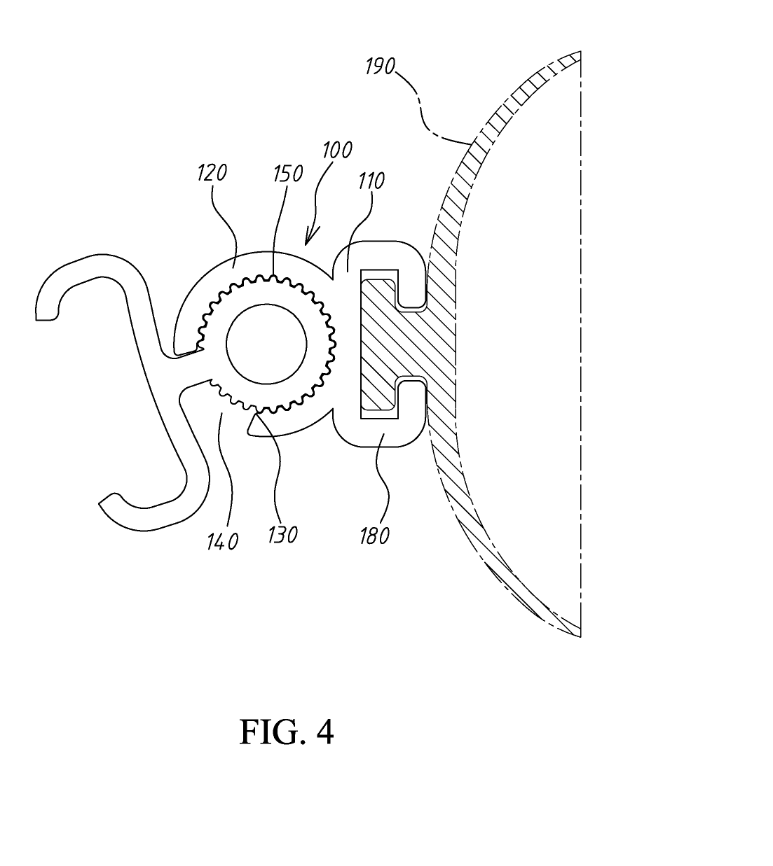

FIG. 4 illustrates another alternate form of the bracket of the aquarium lamp bracket assembly in accordance with the present invention. The bracket 100 in accordance with this alternate form comprises an elongated base frame 110, a coupling tube 120 located at a front side of the elongated base frame 110, a coupling hole 130 axially defined in the coupling tube 120, a longitudinal opening 140 cut through the peripheral wall of the coupling tube 120 and kept in communication with the coupling hole 130, a positioning means, for example, longitudinal positioning teeth 150 spaced around the inner perimeter of the coupling tube 120 within the coupling hole 130, a clamping member 180 located at an opposite side of the elongated base frame 11, and mounting means, for example, a vacuum mount 190 connected to the clamping member 180 and fastenable to a flat surface, for example, one glass panel of an aquarium housing.

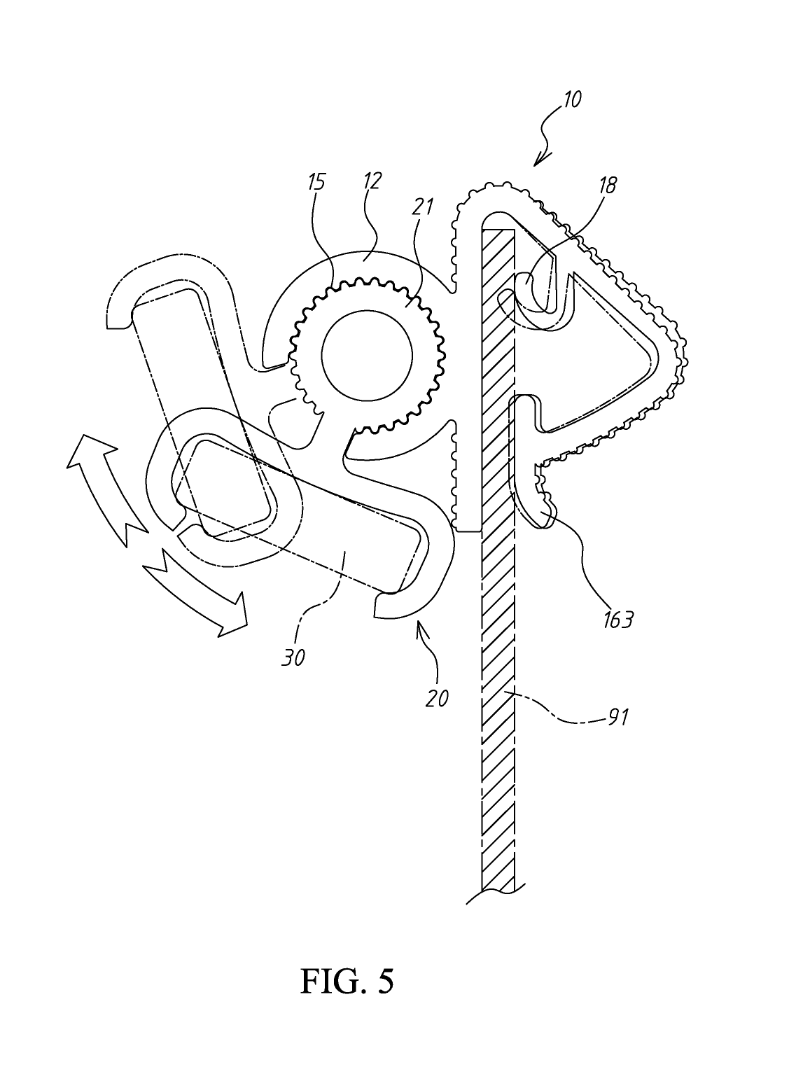

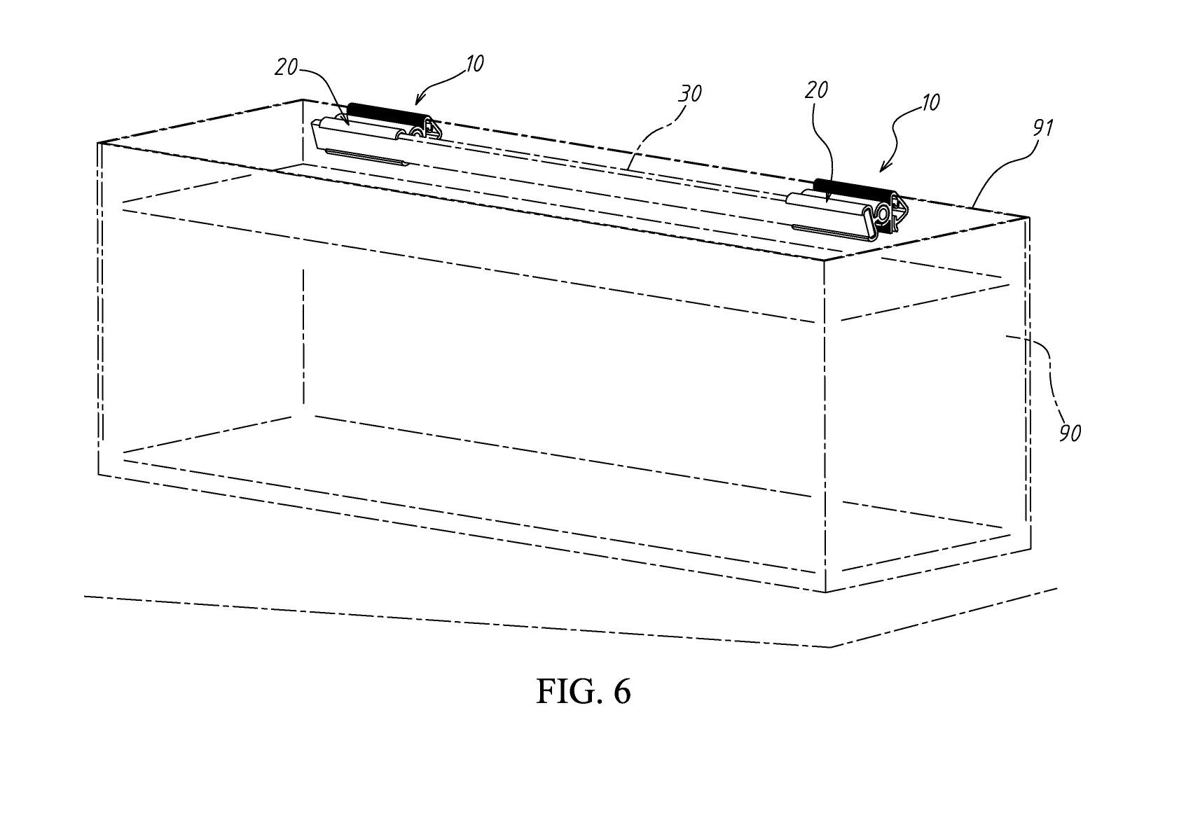

Referring to FIGS. 5 and 6, the pressure plate 163 and auxiliary clamping plate 18 of the clamping member 16, the bracket 10 can be clamped on one glass panel 91 of an aquarium housing 90. After the clamping member 16 is fastened to the glass panel 91 of the aquarium housing 90, the user can bias the rotate the adjustable lamp tube holder 20 relative to the bracket 10 to adjust the angular position of the peripherally toothed pivot shaft 21 in the coupling hole 13 inside the coupling tube 12 to shift the clamping mouth 17 in a range within 21°˜69°.

In conclusion, the invention provides an aquarium lamp bracket assembly, which has the advantages of low manufacturing cost, ease of quick installation and illuminating angle adjustability.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An aquarium lamp bracket assembly, comprising:
a bracket comprising an elongated base frame, a coupling tube located at a front side of said base frame, a coupling hole axially defined in said coupling tube, a longitudinal opening cut through the periphery of said coupling tube and kept in communication with said coupling hole, a positioning means located at the inner perimeter of said coupling tube within said coupling hole, and a clamping member extended from a back side of said elongated base frame and defining a clamping mouth for fastening to a glass panel of an aquarium housing; and
an adjustable lamp tube holder comprising a pivot shaft inserted into said coupling hole in said coupling tube and kept in friction engagement with said positioning means, a lamp tube holder shell for holding a lamp tube, and a neck connected between the periphery of said pivot shaft and a back side of said lamp tube holder shell and inserted through said longitudinal opening of said bracket.

2. The aquarium lamp bracket assembly as claimed in claim 1, wherein said clamping member comprises a first sloping wall obliquely extended from one lateral side of said elongated base frame, a pressure plate disposed in proximity to an opposite lateral side of said elongated base frame and defining with said opposite lateral side of said elongated base frame said clamping mouth, and a second sloping wall obliquely connected between said first sloping wall and said pressure plate.

3. The aquarium lamp bracket assembly as claimed in claim 2, wherein said clamping member further comprises an auxiliary clamping plate located at an inner side of said first sloping wall and kept in proximity to said elongated base frame.

4. The aquarium lamp bracket assembly as claimed in claim 1, wherein said bracket further comprises a mounting means connected to said clamping member for mounting.

5. The aquarium lamp bracket assembly as claimed in claim 4, wherein said mounting means is a vacuum mount.

6. The aquarium lamp bracket assembly as claimed in claim 1, wherein said positioning means of said bracket comprises a plurality of longitudinal positioning teeth spaced around the inner perimeter of said coupling tube within said coupling hole; said pivot shaft of said adjustable lamp tube holder is peripherally toothed for friction engagement with said longitudinal positioning teeth of said bracket.

7. The aquarium lamp bracket assembly as claimed in claim 2, wherein said positioning means of said bracket comprises a plurality of longitudinal positioning teeth spaced around the inner perimeter of said coupling tube within said coupling hole; said pivot shaft of said adjustable lamp tube holder is peripherally toothed for friction engagement with said longitudinal positioning teeth of said bracket.

8. The aquarium lamp bracket assembly as claimed in claim 3, wherein said positioning means of said bracket comprises a plurality of longitudinal positioning teeth spaced around the inner perimeter of said coupling tube within said coupling hole; said pivot shaft of said adjustable lamp tube holder is peripherally toothed for friction engagement with said longitudinal positioning teeth of said bracket.

9. The aquarium lamp bracket assembly as claimed in claim 4, wherein said positioning means of said bracket comprises a plurality of longitudinal positioning teeth spaced around the inner perimeter of said coupling tube within said coupling hole; said pivot shaft of said adjustable lamp tube holder is peripherally toothed for friction engagement with said longitudinal positioning teeth of said bracket.

10. The aquarium lamp bracket assembly as claimed in claim 5, wherein said positioning means of said bracket comprises a plurality of longitudinal positioning teeth spaced around the inner perimeter of said coupling tube within said coupling hole; said pivot shaft of said adjustable lamp tube holder is peripherally toothed for friction engagement with said longitudinal positioning teeth of said bracket.
